(19) United States
(12) Patent Application Publication
(10) Pub. No.: US 2002/0196155 A1
(43) Pub. Date: Dec. 26, 2002

(54) Alarm system and method

(76) Inventor: Wayne F. McNulty JR., Scottsdale, AZ (US)

Correspondence Address: LaValle D. Ptak, Ste. B, 28435 N. 42nd St., Cave Creek, AZ, 85331, US

(21) Appl. No.: 09/886,335

(22) Filed: Jun. 21, 2001

(51) Int. Cl. G08B 21/00

(52) U.S. Cl. 340/686.1; 340/686.2; 340/686.6; 340/556

(57) ABSTRACT

A multi-purpose alarm system is designed to produce an alarm signal in response to the movement of an object relative to a fixed position, such as occurs when doors, gates or windows are opened, or when vehicles are moved. The system operates with an emitter providing a beam of light (such as a laser beam of light) mounted in a fixed location. A mirror or retroreflector is mounted on a movable object to intercept the beam of light and reflect it back to a detector located adjacent the emitter. The detector activates an alarm whenever the movable object is moved a sufficient distance to prevent the mirror or retroreflector from returning the beam of light to the detector. Interruption of the beam of light in its path to the mirror or retroreflector is not required to activate the alarm; although the alarm also is activated in the event of interruption of the beam of light from the emitter.

### BACKGROUND

Alarm systems or security systems are in widespread use for a variety of different purposes. Many such systems are designed to detect the motion of intrusion into a dwelling or into a secured area. Other systems, such as perimeter alarm systems are used to monitor ingress onto a swimming pool apron or into a swimming pool itself.

When used in conjunction with barrier fences and swimming pools, such alarms provide an additional level of protection against pool drowning and home intrusion. Alarm systems of this general type are intended to prevent or reduce undesired entry into private or dangerous areas, typically by detecting the movement by objects into the area and across the perimeter protected by the alarm, or by detecting movement by objects such as doors, gates, windows and the like.

Perimeter alarm systems for monitoring movement into an area such as a perimeter of a swimming pool typically utilize laser beam interruption to monitor such movement. Generally, infrared or invisible laser sources are used with a number of mirrors to create a continuous path around the perimeter of the area to be monitored The initial alignment of such systems is relatively difficult and time consuming. If, at any time after the initial installation, one or more of the mirrors or the laser sources becomes misaligned for any reason (either sudden or gradual) , the beam is interrupted and a false alarm is sounded. Correction of such misalignment typically is time consuming and expensive. Even for a properly aligned laser beam perimeter alarm system, all of the light sources, mirrors and detectors are fixed into position; and the alarm is sounded when some object breaks the beam which is projected around the loop formed by these different parts of the system. As a consequence, false alarms also may be activated by objects which are not intended to trigger or activate the alarm.

A number of patents have been issued which cover the implementation of a laser beam as a key element of an alarm system. For example, the Gally U.S. Pat. No. 3,335,285 discloses an alarm system which uses a laser to detect material in a pre-selected zone. The laser generates and sends out a light beam. The light beam is reflected off several mirrors to a receiver. If the light beam is blocked (that is, by an opaque material), so that the receiver does not receive the light beam, an alarm is sounded. This is the type of system which typically is used in perimeter alarm systems for swimming pools.

The Hedin U.S. Pat. No. 3,623,057 discloses a laser perimeter intrusion detection system. The system of this patent has a laser which generates a light beam. The light beam is reflected off a plurality of mirrors to form an enclosed area, the protected area. When the light beam is broken by an object passing through it, an alarm is sounded. The system further is designed to indicate in which section of the perimeter the light beam was broken.

The Miller U.S. Pat. No. 3,688,298 also discloses a laser perimeter detection system. The Miller patent is similar to the Hedin patent in that the system has a laser which generates a light beam. The light beam is reflected off a plurality of photo cells to form an enclosed area. Miller differs from Hedin in that the system of Miller has a safeguard device which terminates generation of the light beam once it is broken by an object or person moving through it.

Another perimeter alarm system using a laser light source is disclosed in the Schlisser U.S. Pat. No. 3,711,846. The system of this patent also is similar to the systems of the Miller and Hedin patents. Schlisser differs from these other two patents in the manner in which the light beam is analyzed to detect whether or not it has been broken by an object or person moving through the beam.

A different approach is disclosed in the Muncheryan U.S. Pat. No. 3,898,639. The system of this patent is a security surveillance laser system in which the laser unit produces a light beam split into four equal intensity light beams. These four light beams then are used to cover walls, fences or other areas on the premises. When any one of the light beams is broken, a talking alarm mechanism is operated.

In the device disclosed in the Todeschini U.S. Pat. No. 3,987,428, an optical laser security system is disclosed. The system of this patent utilizes a laser to produce a light beam. The light beam then is reflected off a plurality of mirrors to cover an entire open area. A receptor is used to compare the light beam to the original signal, and sounds an alarm if the intensity of the received light beam is not the same as the original light beam which was sent. Again, in order to activate the alarm of this system, it is necessary for an object to interfere with either the projected or reflected light beam.

In the Roeder U.S. Pat. No. 4,027,103, a burglar alarm system is disclosed which dials a telephone number when the alarm system is triggered.

The Stenzani U.S. Pat. No. 4,310,836 discloses a photoelectric barrier used to prevent machine tool accidents. The system disclosed in this patent uses a light beam which scans an area. If the light beam is broken by intrusion of an object, the machine tool is shut down.

The Haag U.S. Pat. No. 4,384,280 discloses an anti-entry device. The device of this patent generates a light beam. The light beam is reflected off the area to be protected by a reflective sheet, and sent to a receiver. An alarm is sounded whenever the light beam is broken. The device of Haag differs from the above mentioned patents in the use of the reflective sheets which reflect the light beam back to the receiver. In all other respects, however, the system triggers an alarm when an object interferes with the light beam.

A pool alarm system is disclosed in the Sackett U.S. Pat. No. 4,701,751. The alarm system of the Sackett patent employs a light beam which is projected across two different height levels of a door entryway. The alarm only is activated if the lower beam is broken and the top beam is not broken. The same overall operating principles, however, still apply with the system of this patent in that an alarm is sounded when an object interferes with or breaks the beam of light.

Another swimming pool alarm system is disclosed in the Feher U.S. Pat. No. 4,910,498. In the system of this patent, an infrared light is reflected by mirrors to form a closed space around a swimming pool. An alarm is sounded when the light beam is broken.

An intrusion detection apparatus is disclosed in the Brittain U.S. Pat. No. 5,019,802. In the system of the Brittain patent, an infrared detector is used to detect changes in infrared light waves or heat which is generated by an intruder. The system also uses a microwave detector to detect motion. These two different types of sensors are used to eliminate false alarm signals. If an alarm is sounded, the system automatically dials 911 for help.

In the system of the Otto U.S. Pat No. 5,365,218, a mobile laser unit is mounted on a platform to send a beam out to scan an area. The light beam then is evaluated to see if there are any intruders on the premises by determining the changes made to the light beam as a result of such intruders. As with the previous systems discussed above, the light beam is interfered with by some object or intruder in order to activate the alarm.

The Peralta U.S. Pat. No. 5,874,898 discloses a detector for monitoring objects falling into a pool. A number of light transmitters and receivers are employed. The transmitters and receivers are mounted around the surface of the pool; and if one of the receivers does not receive a light signal, the alarm is sounded. The operating principles employed with this alarm system are similar to those of the systems described above, namely an object breaks the beam of light in order for the alarm to sound.

The Frucht U.S. Pat. No. 5,901,767 discloses an intruder detection system. The system of this patent uses a light beam which is reflected back when the light beam hits a target. The light beam then is analyzed and recorded; and an alarm is sounded if the analyzed beam matches the characteristics of an intruder. Once again, the object which is required to trigger the alarm must somehow interfere with the light beam in this system, as with all the other systems discussed above.

Other systems which are used to provide security for homes and businesses employ a magnetically operated switch mounted on the door frame or window frame adjacent the door or window which has a magnet on it in close proximity to the magnetically operated switch. So long as the magnet on the door or window is adjacent the switch, the system is in its standby mode; and no alarm is sounded. If the magnet on the window or door is moved away from the magnetically operated switch, however, the switch is opened (or closed, depending upon the circuit configuration) and the alarm circuit is activated to trigger the alarm. While such a system is simple in its operation and installation, it readily is defeated by an intruder utilizing a hand-held magnet or second magnet to maintain the switch position while the door or window is being opened. The additional magnet then may be left in place, or used to maintain the alarm deactivated until it can be completely disabled by the intruder. Consequently, such systems are of relatively little value against experienced thieves.

Other systems have been developed in the prior art which are subject to the various shortcomings described above. Consequently, it is desirable to provide an improved barrier protection system which is simple in construction, easy to install, and effective in operation.

### SUMMARY OF THE INVENTION

It is an object of this invention to provide an improved alarm system.

It is an additional object of this invention to provide an improved barrier alarm system.

It is another object of this invention to provide an improved motion detection alarm system.

It is a further object of this invention to provide an improved alarm system using a beam of light for detecting movement of an object with which the alarm system is employed.

In accordance with a preferred embodiment of the invention, a security system includes an emitter (typically mounted in a fixed location) to provide a beam of light. A reflector is normally positioned on an object to be protected to receive the beam of light from the emitter and to produce a reflected or returned beam of light. A detector is mounted to receive the returned beam of light from the reflector. An alarm system further is coupled with the detector and is activated by failure of the detector to receive the returned beam of light. Such a failure is the result of movement of the reflector relative to the emitter to a position where the reflected or returned beam of light no longer is returned to the detector.

### BRIEF DESCRIPTION OF THE DRAWINGS:

FIG. 1 is a flow chart illustrating the operation of a preferred embodiment of the invention;

FIG. 2 is a schematic block diagram of a preferred embodiment of the invention;

FIG. 3 is a perspective view of one of the components used in conjunction with the embodiment of FIGS. 1 and 2;

FIG. 4 is a perspective view of components used in conjunction with the embodiments of FIGS. 1 and 2; and

FIG. 5 is a perspective view of alternative components to those shown in FIG. 4 illustrating a manner of operation of the preferred embodiment of the invention.

### DETAILED DESCRIPTION

Reference now should be made to the drawings, in which the same reference numbers are used throughout the different figures to designate the same or similar components. The apparatus and system which is disclosed in the drawings, and which comprises the preferred embodiment of the invention, is used to detect movement of objects, such as doors, gates, windows, vehicles, or any other object, when the object is moved from a secured position to some other position. Before entering into a discussion of the specific embodiment of the invention, a brief outline of the overall operation is considered helpful.

The system of the preferred embodiment of the invention may be mounted on any desired object, with appropriate mounting hardware, to protect the property. Typical properties to be protected are areas enclosed by doors or windows,on into open spaces and pool enclosures. By using a transmitter/receiver/reflector system, an alarm is triggered or activated whenever an open condition between the transmitter and receiver occurs. Basically, the alarm activation occurs when the transmitter/receiver detects that an object, such as a door, gate, window or vehicle is moved from an original or protected position to some other position, or that some other interruption has occurred. The system is not easily defeated by using magnets, light sources, drilling or most commonly known techniques for defeating intrusion or perimeter alarms.

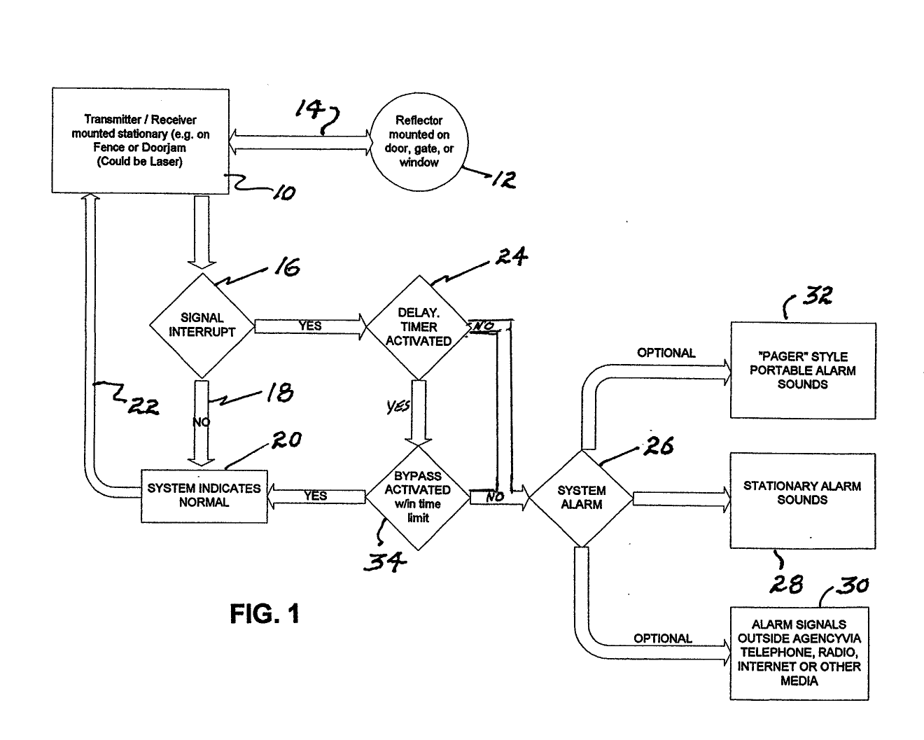

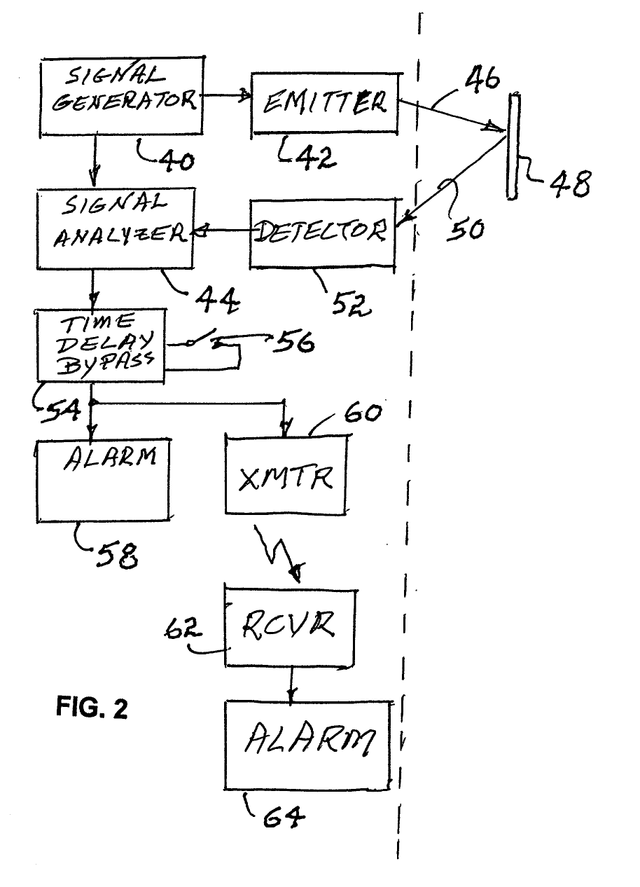

Reference now should be made to FIGS. 1 and 2. FIG. 2 is a block diagram of the preferred system configuration for the security system of a preferred embodiment of the invention. The system shown in FIG. 2, the operation of which is described in conjunction with FIG. 1, typically is employed to monitor the opening of a door or window protected by the system. This is accomplished by use of an emitter 42, which preferably is either a visible or infrared laser producing a narrow collimated beam of light 46. The emitter 42 typically is mounted on the door jamb or window jamb adjacent the door or window to be protected.

As illustrated in FIG. 2, a signal generator 40 is used to operate the laser emitter 42 for the purpose of producing a unique pattern of pulses or signals to lessen the chance that false alarms will be triggered by the system from extraneous light sources. The signal pattern produced by the generator 40 and used to drive the emitter (which then produces a corresponding light beam pattern at 46) also is supplied to a signal analyzer 44, where it is compared with a returned light beam detected by a detector 52.

The other portion of the physical parts of the alarm system comprise a reflector 48 in the form of a mirror or retroreflector. The reflector 48 is positioned to receive the light beam 46, and to produce a returned beam 50 directed at the detector 52. Preferably, the reflector 48 is a retroreflector; so that alignment of the reflector 48, with respect to the emitter 42 and the detector 52, is greatly simplified over that which is required when a mirror is used for the reflector 48. The system, however, works with either a mirror reflector or a retroreflector, or any other type of reflector which is capable of reflecting a light beam impinging upon it.

Typically, the reflector 48 is mounted in close proximity to the source of the light beam 46 on the emitter 42. In the case of doors and windows, the reflector 48 is mounted on the window frame and on the frame of the door itself, directly aligned with the light emitting port of the emitter 42.

When the reflected beam of light 50 is received the detector 52, it is supplied to the signal analyzer 44 where it is compared with the signal from the signal generator 40. If the nature (pulse pattern or other modulation pattern) of the reflected light beam 50 corresponds with the signal produced by the signal generator 40 used to produce the projected light beam 46, no signal is obtained from the output of the signal generator 44. In the event, however, that the reflected beam 50 is not detected while the signal generator 40 is driving the emitter 40 to produce a projected beam 46, or if the signal from the signal generator and the reflected beam 50 are dissimilar, a signal is obtained from the signal analyzer 44, and is supplied through a time delay bypass circuit 54 to sound an alarm. If the time delay bypass is set to zero, which is its normal condition, an alarm 58 is sounded immediately when there is a difference between the projected beam 46 and the returned beam (or lack of returned beam) 50.

It should be noted that FIG. 2 also shows the output of the time delay bypass 54 being supplied to a transmitter 60 as an alternative to the alarm 58, or in addition to the signal supplied to the alarm 58. If a remote alarm, such as an alarm 64, is used with the system, the transmitter 60 transmits the alarm signal to a receiver 62 coupled with the remote alarm 64 to activate that remote alarm. Typical remote alarms may be pagers, alarms located in a central area for responding to activation of any one of a plurality of individual alarm circuits of the type shown in FIG. 2, automatic telephone dialing systems, or the like. The alarms 58 and 64 may be of any suitable type, visible or invisible light actuation, audio systems such as sirens or synthesized voice, or automatic telephones to a predetermined party for emergency response. The particular type of alarm which is used for the alarms 58 and 64 is not important; and any one of a number of different conventional alarm devices and systems may be used for the alarms 58 and 64.

In some situations, such as entry into a home or into an area enclosed by a fence, such as a pool, it may be desirable to allow ingress with a bypass of the alarm system for a relatively short period of time. To accomplish this, the time delay bypass 54 is employed. If a person desires to enter a secured area through an opening which is protected by the system, a momentary push button switch, such as the switch 56, is closed to activate a time delay circuit 54 to prevent any output signals from the signal analyzer 44 from being passed through to the alarm 58 (or transmitter 60) by the time delay bypass 54 for the length of time established by the time delay operated by the momentary closure of the switch 56. This time delay can be set for any desired length of time, depending upon the particular application with which the system is used, and upon the desires of the operators of the system. It may be from a brief delay of two or three seconds up to several seconds or more. It should be noted that while the time delay 54 is in operation, the operation of the signal analyzer 44, which otherwise detects an alarm condition, is prevented from triggering either the alarm 58 or the remote alarm 64 by way of the transmitter 60. Once the time-out period established by the operation of the switch 56 is over, however, the system will operate to activate either of the alarms 58 or 64, or both of them, unless the system has returned to its desired standby status under protection of the alarm system.

FIG. 1 illustrates a flow chart of the operation of the system shown in FIG. 2. In FIG. 1, the transmitter/receiver 10 is indicated as being mounted in a fixed or stationary position. The receiver 10 then supplies a light beam signal 14 to a reflector 12 mounted on a door, gate or window; and the reflected signal is passed back to the transmitter/receiver over the path 14 shown in FIG. 1.

The received signal at the transmitter/receiver 10 is continually monitored at 16 to determine whether or not there is a signal interruption. So long as there is no interruption at 18, the signal is indicated as normal at 20; and this is supplied back to the transmitter/receiver at 22. No other operation of the system takes place. The alarm is quiet.

If, however, at 16 a signal interruption is detected, a decision is made at 24 as to whether or not the interruption is covered by a delayed timer activation. If it is not, a system alarm is made at 26;and a stationary alarm is sounded at 28, or optional pager or portable alarms are sounded at 32, or optional alarm signals for an outside agency, such as telephone, radio or other media, are effected at 30. If, however, the delay timer is activated at 24, a bypass activation is indicated at 34; and this is provided to the system normal indication at 20 and no alarm is sounded. If the delay timer has been activated and the time-out of the bypass activation is indicated at 34, the system is outside the time window (the time limit has expired); so that the alarm is activated at 26 in the same manner as described above, with the no decision at 24.

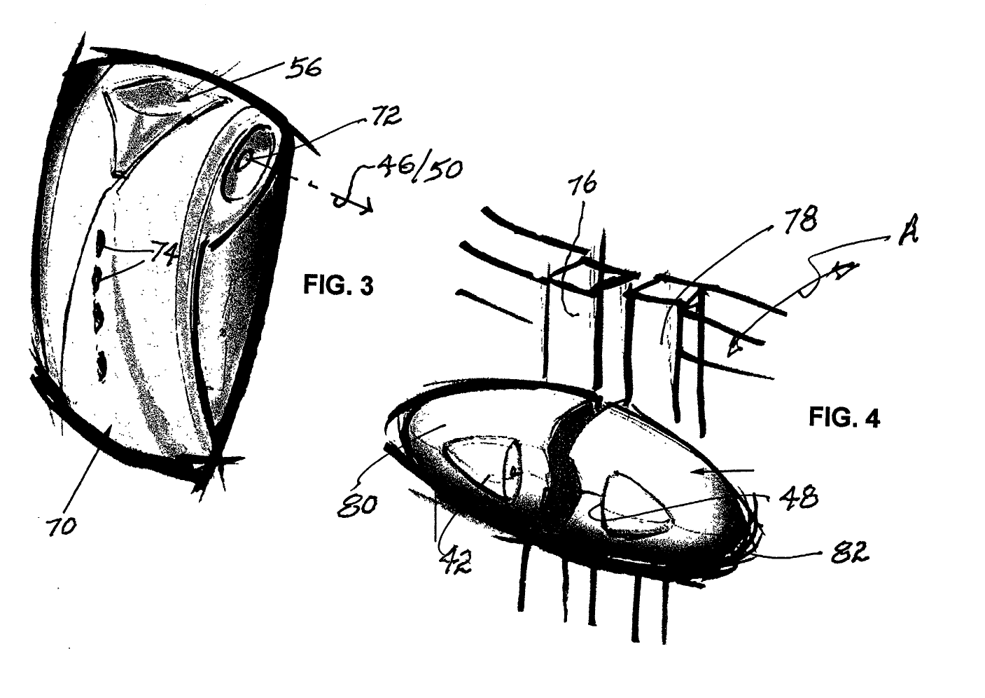

FIG. 3 is a perspective view of possible configuration of a specific emitter, such as the emitter 42, which may be used with the system. This is a laser light transmitter device, and it is indicated as a device 70 in FIG. 3 projecting a collimated laser beam of light 46 through an aperture 72.

The reflected beam, particularly if it is reflected from a retroreflector, also is returned on the same centerline (or a parallel centerline) as the projected beam to a detector 52 (not shown in FIG. 3) located inside the housing 70. The time delay bypass switch 56 may be provided in the form of a push button on the top of the housing 70; and apertures 74 are provided for allowing audible signals to pass out of the body 70 from an alarm 58 located within the housing 70. It should be noted that the alarm system which is described in conjunction with FIGS. 1 and 2, and a housing for which is shown in FIG. 3, may employ either a battery power supply; or it may be hard wired into the electrical distribution system of the building in which is located. For a hard wired system, it is desirable to have a battery backup for maintaining operation of the transmitter/receiver unit in the event of a power failure.

FIG. 4 is a perspective representation of a possible configuration, differing slightly from the one of FIG. 3, for both the transmitter/receiver housing and the reflector housing of a pair units used with a typical system of the type shown in FIG. 2. As illustrated in FIG. 4, a housing 80 is mounted in a fixed position to a door jamb or window jamb 76. The housing 80 includes all of the electronic components which are shown in FIG. 2 (with the exception of the remote receiver 62 and remote alarm 64); and it includes a portion 42 housing the emitter 42 described above in conjunction with FIG. 2. Adjacent the fixed housing 80 on a movable door or window 78 is the housing 82 for the reflector 48. As shown in FIG. 4, when the door or window is closed, the reflector 48 is in close proximity to the emitter 42, with the projected beam of light 46 and the reflected or returned beam of light 50 passing a short distance between the two units. If the reflector unit 48 is moved by movement of the door or window 78 out of the common axis between the reflector 48 and the emitter 42, the detector 52 of FIG. 2 will cease to receive the returned or reflected beam of light; and an alarm will be activated as described previously.

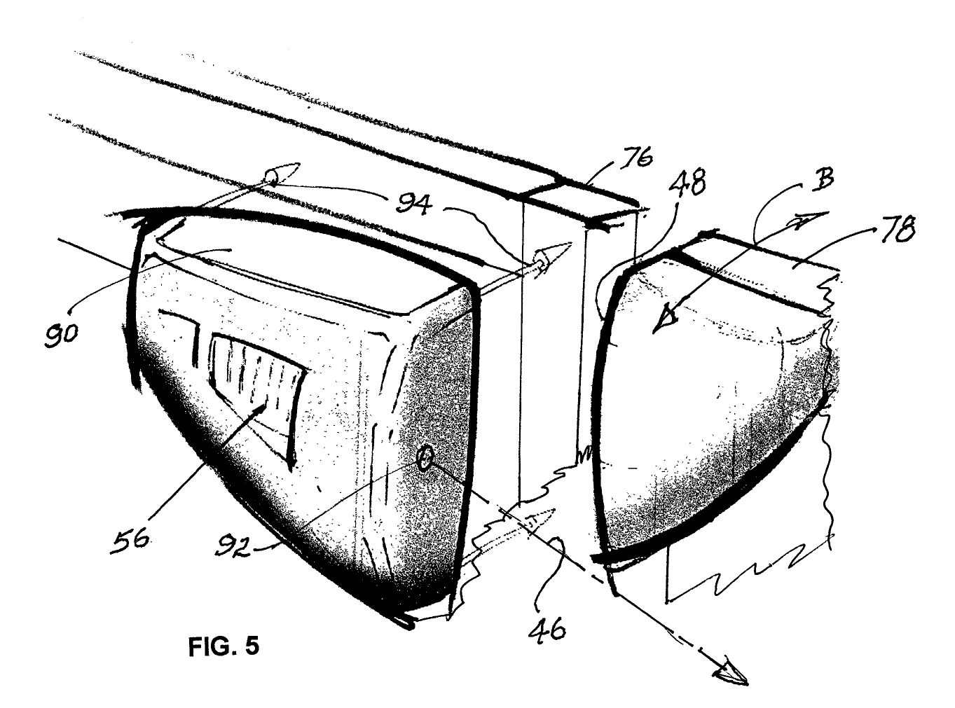

The manner of activation of an alarm is illustrated most clearly in the embodiment shown in FIG. 5. In FIG. 5, different housings 90 for the transmitter/receiver portion of the system and for the reflector portion 48 are shown. When the reflector portion is moved in the direction of the arrows B on the frame 78, away from the fixed frame 76 on which the housing 90 is mounted, the projected beam 46 from the aperture 92 in the housing 90 does not contact the reflector 48; so there is no returned beam or reflected beam 50 for the receiver portion of the transceiver in the housing 90. The other elements, such as the override switch 56, are further illustrated in FIG. 5.

FIG. 5 also shows a suggested form of mounting the housing 90 on the door jamb or window jamb 76; although the mounting of the housing of any of the various transceiver portions of the invention may be effected by any suitable means, such as threaded fasteners, nails, screws, hook and loop fasteners, or the like. It also should be noted that while the fixed housing for the transceiver portion of the system has been described as connected to a fixed door jamb or window jamb of an installation, the location of the reflector 48 and the transceiver housing, such as the housings 70, 80, 90 may be reversed. The system operates the same, irrespective of which of the two parts of the system are moved relative to the other. It is relative movement between the transceiver portion and the reflector portion which is employed to operate the system.

Other features may be added to the system which has been described above and which is shown in the various figures of the drawings. For example, the transceiver unit may be provided with a brief time delay mechanism in the signal analyzer 44 to prevent premature sounding of the alarm due to raindrops, wind, blowing leaves or the like. In addition, whenever the alarm activation, whether the stationary alarm 28 or pager alarm 26, or other optional alarms 30, is occurring, the system may be operated to turn off the signal generator and the emitter 42. Alignment once again will be searched for when an appropriate reset control (not shown) is operated. This operation may prevent injury and it forces a manual reset of the system after an alarm has been sounded. A low battery signal may be incorporated for those versions of the system which employ battery power as the sole source of energy for the system. Such low battery signals are well known in conjunction with a variety of electronic products, such as smoke detectors.

The foregoing description of a preferred embodiment of the invention is to be considered illustrative and not as limiting. Various changes and modifications will occur to those skilled in the art for performing substantially the same function, in substantially the same way, to achieve substantially the same result, without departing from the true scope of the invention as defined in the appended claims.

What is claimed is

1. A security alarm system including in combination:
an emitter providing a beam of light;
a reflector normally positioned to receive the beam of light from the emitter and to return the beam of light as a returned beam;
a detector for receiving the returned beam of light from the reflector; and
an alarm system coupled with the detector and activated by failure of the detector to receive the returned beam of light;
wherein one of the emitter and the reflector are mounted in a fixed location and the other of the emitter and the reflector are mounted for movement relative to the fixed location; so that in positions other than the position in which the reflector is normally positioned to receive the beam of light from the emitter, no returned beam of light is received by the detector.

2. The system according to claim 1 wherein the emitter projects a collimated beam of light.

3. The security system according to claim 2 wherein the emitter is a laser light source.

4. The security alarm system according to claim 3 wherein the emitter is mounted in a fixed location and the reflector is mounted in a location capable of movement from a normal position to a position where the beam of light from the emitter does not strike the reflector.

5. The security alarm system according to claim 4 further including a signal generator coupled with the emitter for providing a beam of light having a unique signal pattern.

6. The security alarm system according to claim 5 further including a signal analyzer coupled between the detector and the alarm system and further coupled with the signal generator for comparing the signal characteristics of the returned beam of light with the signal characteristics of the unique signal pattern from the signal generator to provide an output signal for activating the alarm system whenever the signal of the signal generator and the signal pattern of the returned beam are not the same.

7. A security alarm system according to claim 6 wherein the alarm system includes a transmitter coupled with the detector for transmitting an alarm signal upon failure of the detector to receive the returned beam of light; and a receiver responsive to the signal from the transmitter for activating an alarm indicative of failure of the detector to receive the returned beam of light.

8. The security alarm system according to claim 6 wherein the reflector comprises a mirror.

9. The security alarm system according to claim 6 wherein the reflector comprises a retroreflector.

10. The security alarm system according to claim 1 wherein the emitter is mounted in a fixed location and the reflector is mounted in a location capable of movement from a normal position to a position where the beam of light from the emitter does not strike the reflector.

11. The security alarm system according to claim 1 further including a signal generator coupled with the emitter for providing a beam of light having a unique signal pattern.

12. The security alarm system according to claim 11 further including a signal analyzer coupled between the detector and the alarm system and further coupled with the signal generator for comparing the signal characteristics of the returned beam of light with the signal characteristics of the unique signal pattern from the signal generator to provide an output signal for activating the alarm system whenever the signal of the signal generator and the signal pattern of the returned beam are not the same.

13. A security alarm system according to claim 1 wherein the alarm system includes a transmitter coupled with the detector for transmitting an alarm signal upon failure of the detector to receive the returned beam of light; and a receiver responsive to the signal from the transmitter for activating an alarm indicative of failure of the detector to receive the returned beam of light.

14. The security alarm system according to claim 1 wherein the reflector comprises a mirror.

15. The security alarm system according to claim 1 wherein the reflector comprises a retroreflector.

16. A security system including in combination:
a retroreflector mounted on a movable object, the position of which is continuously monitored to detect movement of the object from a desired normal position to some other position;
a light emitter mounted in a fixed location relative to the location of the retroreflector for projecting a beam of light to the retroreflector in the normal position thereof to cause the retroreflector to produce a returned beam of light;
a detector positioned adjacent the emitter for receiving the returned beam of light from the retroreflector; and
an alarm coupled with the detector and activated by failure of the detector to receive the returned beam of light whenever the retroreflector is moved by a predetermined amount from the normal position thereof.

17. The system according to claim 16 wherein the emitter projects a collimated beam of light.

18. The security system according to claim 17 wherein the emitter is a laser light source.

19. A security system according to claim 16 wherein the retroreflector is mounted on an object selected from the class of doors, gates and windows for movement therewith.

20. The system according to claim 19 wherein the emitter projects a collimated beam of light.

21. A security alarm system according to claim 16 further including a time delay bypass coupled with the detector for preventing activation of the alarm for a predetermined time interval established by the time delay bypass.

22. A method for providing an indication of breach of security by movement of one object relative to another including the steps of:
placing a light emitter on a first object to project a beam of light;
placing a reflector on a second object for receiving the beam of light in a normal secure position to return the beam of light to a particular location relative to the emitter; and activating an alarm upon failure of the returned beam of light to reach the predetermined position as a result of movement of the emitter and the reflector relative to one another.

23. The method according to claim 22 further including the step of interrupting activation of the alarm for a predetermined period of time.
